(19) United States
(12) Patent Application Publication
(10) Pub. No.: US 2011/0177740 A1
(43) Pub. Date: Jul. 21, 2011

(54) Flame Resistant Blends

(76) Inventor: Richard Waxman, Manchester (GB)

(21) Appl. No.: 13/055,239

(22) PCT Filed: Jun. 15, 2009
(86) PCT No.: PCT/GB2009/050676

§ 371 Date: Apr. 4, 2011

(30) Foreign Application Priority Data
Jul. 22, 2008 (GB) GB0813401.7
Jun. 15, 2009 (GB) PCT/GB2009/050676

(51) Int. Cl. D03D 15/12; C08L 33/20; D04B 1/14; D04H 13/00

(52) U.S. Cl. 442/302; 524/34; 442/304; 442/414

(57) ABSTRACT

A flame retardant fibre blend comprising 40% to 60% by weight of a modacrylic; 5% to 25% by weight of a natural cellulosic material; and 20% to 40% by weight of a FR viscose based material; wherein any remaining weight % is made up of any one or a combination of the modacrylic, cellulosic or FR viscose. The fibre blend is particularly suitable for the manufacture of a ‘universal’ fabric configured to be resistant to flame, electric discharge and molten metal hazards.

The present invention relates to a flame resistant fibre blend and in particular, although not exclusively, to yarns, fabrics, garments and non-woven products prepared from a flame resistant fibre blend.

Flame Resistant (FR) materials are employed in many textile applications. In particular, FR materials are used as barrier layers to protect more flammable internal components such as inner stuffing within furniture including mattresses, sofas and the like. FR materials are also used to make FR clothing used in specific industrial applications and the military.

First generation fire resistant materials, particularly for the construction of garments to be worn, were based on natural fibres, including in particular wool and cotton. The flame retardant functionality was provided by chemically treating the natural yarns with phosphorous based flame retardant chemicals. The resultant garments, whilst being resistant to flames were however disadvantageous for a number of reasons. In particular, these early FR garments were uncomfortable to wear for reasonable periods as they were typically heavy with the wearer becoming increasingly hot. More recently, synthetic FR blends have been developed with a view to providing lighter more breathable garments so as to increase comfort.

US 2008/0145543 discloses a high performance FR textile fabric for use in producing close fitting garments, such as undergarments, in direct contact with the skin. The fabric is formed from yarns of rayon filaments, and a cured phosphorous-based flame retardant compound is affixed to the filaments and imparts further flame retardant properties to the fabric.

US 2005/0204718 discloses a blended yarn designed to provide arc and flame protective properties. The yarn is manufactured from 40% to 70% by weigh of a modacrylic, 5% to 20% by weight of p-aramid and 10% to 40% by weight of m-aramid. The entirely synthetic material is designed to achieve a tensile strength sufficient to be resistant to ‘break-open’ when exposed to an electric arc.

WO 2008/027454 discloses flame resistant fabrics comprising a blend of a synthetic cellulosic and a FR modacrylic. Garments produced from the fibres are designed to be resistant to electric arc flash and flames.

However, whilst these more recent synthetic FR textiles perform better than the earlier natural fibre based garments there are a number of disadvantages. Firstly, entirely synthetic FR garments are expensive for a number of reasons. The component fibres are typically only available from specialist manufacturers resulting in limited availability. Secondly, the manufacture of these component fibres is complex, requiring a variety of chemical processing steps. Thirdly, FR textiles made entirely from synthetic fibres are typically uncomfortable for the wearer due, in part, to their poor softness and breathability characteristics.

There is therefore a need for a flame retardant fibre blend that may be conveniently and efficiently mass produced for the manufacture of FR garments that satisfy the required national and/or international safety standards whilst being comfortable for the wearer.

Accordingly, the inventors provide a fibre blend that is designed to be breathable, soft and provide moisture management characteristics. The present fibre blend is also configured to be multipurpose being suitable for use as a safety garment that offers a protective function within a variety of very different hazardous environments. Utilising natural materials further provides for a cost effective solution to the problem of increasing the FR of a textile.

For example, fabrics manufactured from the present fibre blend are configured to satisfy a variety of different safety standards including in particular, flame retardance; metal splash; electric arc and contact heat performance tests.

The present fibre blend comprises both synthetic and natural fibres. In particular, a natural cellulosic material is employed to provide a garment that is comfortable for the wearer due, in part, to the breathability and softness. The moisture management characteristics of the resulting textiles are also enhanced due primarily to the ‘wicking’ characteristics resultant from the synergistic combination of the natural and synthetic materials.

According to a first aspect of the present invention there is provided a flame retardant fibre blend comprising:
40% to 60% by weight of a modacrylic;
5% to 25% by weight of a natural cellulosic material; and
20% to 40% by weight of a FR viscose based material;
wherein any remaining weight % is made up of any one or a combination of the modacrylic, cellulosic or FR viscose.

The term modacrylic fibre refers to a modified version of acrylonitrile which is resultant from the copolymerisation of acrylonitrile with another compound. The copolymer may comprise 30% to 70% by weight of acrylonitrile and 70% to 30% by weight of a halogen-containing vinyl monomer. The halogen-containing vinyl monomer is preferably at least one monomer selected from vinyl chloride or vinylidene chloride.

Preferably, the modacrylic fibres are copolymers of acrylonitrile combined with vinylidene chloride, the copolymer further comprising at least one type of antimony oxide for improved fire retardancy. In particular, antimony trioxide and/or pentoxide may be used to dope the resultant copolymer. Accordingly, the flame retardant, physical and mechanical properties of the fibre blend may be tailored by, in particular, variation of the type and quantity of the antimony oxide added.

According to specific implementations, the modacrylic fibre of the present invention comprises the fibres disclosed in U.S. Pat. No. 3,193,602; U.S. Pat. No. 3,748,302; U.S. Pat. No. 5,208,105 and U.S. Pat. No. 5,506,042.

The preferred modacrylic fibres of the present invention are fibres based on Kanecaron™ (available from Kaneka Corporation, Kanecaron Division, 3-2-4, Nakanoshima, Kita-ku, Osaka 530-8288, Japan). Reference to Kanecaron™ includes Kanekaron™ and Kanekaron™.

More preferably, the present fibre blend may comprise any one or a combination of different grades of Protex™ selected from: Protex™ W; Protex™ M; Protex™ T; and/or other modacrylic FR materials falling within the Protex™ family and available from Kaneka.

Preferably, the modacrylic comprises Protex™ T. Optionally, the modacrylic may comprise Sevel™ (available from Fushun Huifu Fire Resistant Fibre Co Limited, No 54, West Section Anshan Road, Fushun City, CN-113001 Lianong, China). Optionally, the modacrylic may comprise Tairylon™ (available from Formosa Chemical & Fibre Corporation, 201 Tung Hwan Road, Teipei, Taiwan, R.O.C).

The FR viscose may be sourced from a plurality of different manufacturers to suit the FR, physical and mechanical performance as required. In particular, and optionally, the FR viscose comprises Lenzing FR™ (available from Lenzing Fibres Inc, Aktiengesellschaft, 4860 Lenzing, Austria). Optionally, the FR viscose may be sourced from Shandong Helon Co. Ltd, No 555, Hai Long Road, Hanging District, Wei Fang, SDG 261100, China (herein referred to as Helon FR).

Preferably, the natural cellulosic material comprises any one or a combination of the following set of: Natural Cotton; Bamboo; Linen; and/or Jute. Reference to ‘natural cellulosic’ refers to a cellulosic material that has not been pre-treated so as to change the chemical, physical or mechanical properties including in particular enhancement of FR. This term also refers to a material available from a biological source such as a plant or shrub. The term includes such natural materials that have undergone minimal processing such that the resultant materials cannot be categorised as synthetic or ‘man-made’.

Optionally, the blend may further comprise nylon in the amount trace to 7% by weight or more preferably trace to 5% by weight.

Optionally, the blend may further comprise an antistatic material and in particular a carbon based antistatic material in the amount trace to 5% by weight. The carbon or non-carbon based antistatic material may be sourced from a plurality of different manufacturers to satisfy the desired physical and mechanical properties as required. However and preferably, the antistatic material comprises any one or a combination of the following set of: Beltron™ (available from KB Seiren Limited, 14-15F, Umeda Daibiru Building, 3-3-10, Umeda, Kita-ku, Osaka, 530-0001 Japan); Negastat™ (available from William Barnet & Son, LLC, 1300 Hayne Street, P.O. Box 131 Arcadia, S.C., 29320, United States of America); and/or Bekinox™ (available from Bekaert, President Kennedypark 18, B-8500 Kortrijk, Belgium).

Preferably, the fibre blend comprises 40% to 55% by weight of the modacrylic; 10% to 20% by weight of the natural cellulosic material; and 25% to 35% by weight of the FR viscose based material.

More preferably, the fibre blend comprises: 45% to 55% by weight of Protex™ T; 10% to 20% by weight of natural cotton; 25% to 35% by weight of FR viscose; trace to 7% by weight nylon; and trace to 5% by weight of a carbon based antistatic material.

According to a further aspect of a present invention there is provided a fabric comprising a fibre blend as disclosed herein. According to a further aspect of the present invention there is provided a garment comprising a fabric made from the fibre blend as disclosed herein.

According to a yet further aspect of the present invention there is provided a flame retardant fibre blend comprising:
40% to 60% by weight of a modacrylic;
5% to 25% by weight of a synthetic non-FR enhanced cellulosic; and
20% to 40% by weight of a FR viscose based material;
wherein any remaining weight % is made up of any one or a combination of the modacrylic, cellulosic or FR viscose.

The present fibre blend is designed specifically for the manufacture of safety textiles being resistant to heat including extreme heat associated with molten metals, electric discharge and flames. The inventors provide a fibre blend and in particular a woven, non-woven, including a knitted fabric, that satisfies a number of different national performance test standards including in particular:

EN ISO 11611:2007: Clause 6.1—tensile strength; Clause 6.2—tear strength; Clause 6.5—dimensional change; Clause 6.7—flame spread procedure A (surface ignition) and B (edge ignition); Clause 6.10—electrical resistance.

EN ISO 11612:2008: Clause 7.4—molten aluminium splash; Clause 7.5—molten iron splash; Clause 7.6—contact heat.

EN 469:2005: Clause 6.4—residual tensile strength of material when exposed to radiant heat; Clause 6.8.2—surface wetting.

A protective fabric, particularly formed as a garment, capable of satisfying the above performance test requirements and based on a natural cellulosic material would provide significant advantages over existing FR fabrics. For example, the present safety fabric satisfies all of the above requirements and is capable of being characterised as a ‘universal’ safety fabric suitable for use in a variety of different hazardous environments as may be required by personnel working in for example, the military, rescue/emergency services and the metal manufacturing, utilities (oil, gas and electric), petrochemical and heavy industries.

The significant problem addressed by the inventors is the propensity of molten metals, including in particular aluminium, to adhere to fabrics incorporating modacrylic fibres to such an extent that skin below the fabric would be damaged to a significant extent to cause a second-degree burn injury to a wearer of the garment. The standard ISO 11612 requires that molten metal be poured onto the fabric at a determined angle laid over simulated skin. The pseudo skin should not show any signs of damage after the pour and the metal should not adhere to the fabric. The standard requires heat resistance testing with exposure to four metals and bauxite. However, it is conventionally recognised that the two main indicators of performance are molten aluminium (class D) and molten iron (class E). These two classes are further divided into three indices as follows:
(a) for aluminium: Index 1 minimum 100 g molten metal
Index 2 minimum 200 g molten metal
Index 3 minimum 350 g molten metal
(b) for iron: Index 1 minimum 60 g molten metal
Index 2 minimum 120 g molten metal
Index 3 minimum 200 g molten metal

The inventors identified the following criteria as being particularly important in the development of a universal heat resistant fibre:

(a) required to pass the FR requirements of ISO11612 and associated Standards namely to withstand both face ignition source (as the previous Standard EN531) AND bottom-edge ignition source (as specifically required in the new replacement Standard ISO11612 and associated standards);

(b) required to achieve at least Class D1 for molten aluminium protection;

(c) required to achieve at least Class E1 for molten iron protection;

(d) to have minimum tensile and tear strength properties of at least the minima specified in ISO11612;

(e) to possibly achieve the requirements of Oekotex (Ökotex) 100 “Standard”. Oekotex is a voluntary, non-Statutory, requirement for measurement of hazardous substances as defined only by the Oekotex organisation but may be used as a bench-mark by some end users. One of the qualifying criteria concerns the measurement of extractable antimony, which is used in the flame-retardant technology inherent to the modacrylic family of fibres.

Modacrylic fibres based on Protex™ W, Protex™ M and Protex™ T were identified as suitable components for the present fibre blend due to their FR grading. However, Protex™ T is generally acknowledged to be less ‘protective’ when employed in the manufacture of a garment due to its expected performance with respect to ‘charring’ protection (associated with barrier formation within the textile to prevent flame penetration).

To illustrate the present invention, the following examples are provided. Test results, for the above criteria are also presented and confirm the advantages of the subject invention and its suitability for use as a component fibre of a protective textile and garment exhibiting degradation resistance to a variety of different hazardous environmental conditions involving significant elevated temperatures.

### EXAMPLE 1

A fibre blend was ring spun on a cotton system to 40/2 NM. The fabric was woven to a twill construction at approximately 360 gsm. The fibre blend comprised 50% Protex™ M; 30% Helon FR viscose; 15% cotton and 5% nylon.

### EXAMPLE 2

A fibre blend was ring spun on a cotton system to 40/2 NM. The fabric was woven to a twill construction at approximately 360 gsm. The fibre blend comprised 50% Protex™ W; 30% Helon FR viscose; 15% cotton and 5% nylon.

### EXAMPLE 3

A fibre blend was ring spun on a cotton system to 40/2 NM. The fabric was woven to a twill construction at approximately 360 gsm. The fibre blend comprised 50% Protex™ T; 30% Helon FR viscose; 15% cotton and 5% nylon.

### EXAMPLE 4

A fibre blend was ring spun on a cotton system to 40/2 NM. The fabric was woven to a twill construction at approximately 360 gsm. The fibre blend comprised 50% Protex™ M; 30% Lenzing™ FR viscose; 15% cotton and 5% nylon.

### EXAMPLE 5

A fibre blend was ring spun on a cotton system to 40/2 NM. The fabric was woven to a twill construction at approximately 360 gsm. The fibre blend comprised 50% Protex™ W; 30% Lenzing™ FR viscose; 15% cotton and 5% nylon.

### EXAMPLE 6

A fibre blend was ring spun on a cotton system to 40/2 NM. The fabric was woven to a twill construction at approximately 360 gsm. The fibre blend comprised 50% Protex™ T; 30% Lenzing™ FR viscose; 15% cotton and 5% nylon.

Performance testing was undertaken for the fibre blends of examples 3 and 6 and the results are presented in tables 1 to 6 below.

Test Results—Example 3

Tables 1 to 3 detail the experimental performance test results for the blend formulation of example 3 according to the identified performance criteria of each of the three standards EN ISO 11611:2007; EN ISO 11612:2008 and; EN 469:2005.

Performance Test—EN ISO 11611:2007

Standard: Clause 6.1—tensile strength; Clause 6.2—tear strength; Clause 6.5—dimensional change; Clause 6.7—flame spread procedure A (surface ignition) and B (edge ignition); Clause 6.10—electrical resistance.

Pre-treatment: for 6.1, 6.2, 6.5 and 6.10 tests were made after 5 washing cycles in accordance with ISO 6330:2000. Procedure 6A at 40° C. drying procedure E: tumble dry. The tumble drying was carried out after the completion of each wash. For 6.7 tests were made in the as received condition.

TABLE 1
Standard EN ISO 11611: 2007-Test results for the blend of example 3.

| | | ISO 11611 Requirement & | | | PASS/Fail |
|---|---|---|---|---|---|
| Clause | Test Method | Performance Levels | Results | | or Class |
| 6.1*** | ISO | Class 1 & 2 | Warp | 980N | LIKELY TO |
| Tensile strength | 13934-1: 1999 | Min. of 400N in both the warp | Weft | 930N | MEET |
| | | and weft directions | | | CLASS 1 & |
| | | | | | CLASS 2 |
| 6.2*** | ISO | Class 1 & 2 | Torn across | 32.1N | LIKELY TO |
| Tear strength | 13934-1: 2000 | Min. of 20N in both the warp and | warp | | MEET |
| | | weft directions | Torn across | 29.7N | CLASS 1 & |
| | | | weft | | CLASS 2 |
| 6.5 | ISO 5077 | Class 1 & 2 | Warp | Weft | FAIL |
| Dimensional | | Max ± 3% | −7.0 % | −4.5% | |

| | | | | |
|---|---|---|---|---|
| change | | (− indicates shrinkage) | (− indicates shrinkage) | |
| 6.7**** | ISO 15025: 2000 | Class 1 & 2 | Procedures A & B | LIKELY TO |
| Limited | | No flaming to top or side edge | No flaming to top or side edge | MEET |
| flame spread | | No hole formation (A only) | No hole formation | CLASS 1 & |
| (procedures A & B) | | No flaming or molten debris | No flaming or molten debris | CLASS 2 |
| | | Mean afterflame ≦ 2 s | No afterflame | |
| | | Mean afterglow ≦ 2 s | No afterglow | |
| 6.10 | EN 1149-2: 1997 | Class 1 & 2 | Resistance = 5.2 × 10⁶ | CLASS 1 & |
| Electrical Resistance | | Electrical resistance greater than | | CLASS 2 |
| ***** | | 10⁵ Ohms | | |

***test made on two warpway and weftway specimens only
****test made on one warpway and weftway specimen only and without pre-treatment
*****sub contracted test made by STFI

Performance Test—EN ISO 11612:2008

Standard: Clause 7.4—molten aluminium splash (D); Clause 7.5—molten iron splash (E); Clause 7.6—contact heat (F).

Pre-treatment: tests were made after 5 washing cycles in accordance with ISO 6330:2000. Procedure 6A at 40° C. drying procedure E: tumble try. The tumble drying was carried out after the completion of each wash.

TABLE 2
Standard EN ISO 11612: 2008-Test results for the blend of example 3.

| | | ISO 11612 Requirement & | | | | | | PASS/Fail |
|---|---|---|---|---|---|---|---|---|
| Clause | Test Method | Performance Levels | | | Results | | | or Class |
| 7.4 | ISO 9185 | Molten AL splash (g) | | | Spec | Poured(g) | Skin stimulant | LEVEL D1 |
| Molten Aluminium | | Performance levels | | | 1 | 203 | Damaged | |
| splash (D) | | | Min | Max | 2 | 102 | Undamaged | |
| | | D1 | 100 | <200 | 3 | 105 | Undamaged | |
| | | D2 | 200 | <350 | 4 | 107 | Undamaged | |
| | | D3 | 350 | | 5 | 108 | Undamaged | |
| 7.5 | ISO 9185 | Molten Iron splash (g) | | | Spec | Poured(g) | Skin stimulant | LEVEL E3 |
| Molten Iron Splash | | Performance levels | | | 1 | 200 | Undamaged | |
| (E) | | | Min | Max | 2 | 202 | Undamaged | |
| | | E1 | 60 | <120 | 3 | 203 | Undamaged | |
| | | E2 | 120 | <200 | 4 | 202 | Undamaged | |

| | | E3 | 200 | | | | |
|---|---|---|---|---|---|---|---|
| 7.6 | ISO 12127: 1996 | Threshold time (s) | | | Specimen 1 | 5.2 | LEVEL F1 |
| Contact Heat (F)** | at 250° C. | Performance levels | | | Specimen 2 | 5.2 | |
| | | | Min | Max | Specimen 3 | 5.1 | |
| | | F1 | 5.0 | <10.0 | Result | 5.1 | |
| | | F2 | 10.0 | <15.0 | based on lowest | | |

| | |
|---|---|
| F3 | 15.0 |

**sub contracted test made by UKAS accredited laboratory

Performance Test—EN 469:2005

Standard: Clause 6.4—residual tensile strength of material when exposed to radian heat; Clause 6.8.2—surface wetting.

Pre-treatment: tests were made after 5 washing cycles in accordance with ISO 6330:2000. Procedure 6A at 40° C. drying procedure E: tumble dry. The tumble drying was carried out after the completion of each wash.

TABLE 3
Standard EN 469: 2005-Test results for the blend of example 3.

| | | ISO 11612 Requirement & | | | PASS/Fail |
|---|---|---|---|---|---|
| Clause | Test Method | Performance Levels | Results | | or Class |
| 6.4 | EN ISO 13934-1 | Each specimen shall have a | Weft | | LIKELY TO |
| Residual tensile | pre-treatment to | tensile strength ≧ 450N | Specimen 1 | 820N | PASS |
| strength***** | EN ISO 6942: 2002 | | | | |
| | Method A, at heat | | | | |
| | flux density of | | | | |
| | 10 kW/m² | | | | |
| 6.8 | EN 24920: 1992 | Spray rate of ≧4 | Specimen 1 | 1 | FAIL |
| Surface wetting | | | | | |

*****test made on one weftway specimen only

Test Results—Example 6

Tables 4 to 6 detail the experimental performance test results for the blend formulation of example 6 according to the identified performance criteria of each of the three standards EN ISO 11611:2007; EN ISO 11612:2008 and; EN 469:2005.

Performance Test—EN ISO 11611:2007

Standard: Clause 6.1—tensile strength; Clause 6.2—tear strength; Clause 6.5—dimensional change; Clause 6.7—flame spread procedure A (surface ignition) and B (edge ignition); Clause 6.10—electrical resistance.

Pre-treatment: for 6.1, 6.2, 6.5 and 6.10 tests were made after 5 washing cycles in accordance with ISO 6330:2000. Procedure 6A at 40° C. drying procedure E: tumble dry.

The tumble drying was carried out after the completion of each wash. For 6.7 tests were made in the as received condition.

TABLE 4
Standard EN ISO 11611: 2007-Test results for the blend of example 6.

| | | ISO 11611 Requirement & | | | PASS/Fail |
|---|---|---|---|---|---|
| Clause | Test Method | Performance Levels | Results | | or Class |
| 6.1*** | ISO | Class 1 & 2 | Warp | 970N | LIKELY TO |
| Tensile strength | 13934-1: 1999 | Min. of 400N in both the warp | Weft | 890N | MEET |
| | | and weft directions | | | CLASS 1 & |
| | | | | | CLASS 2 |
| 6.2*** | ISO | Class 1 & 2 | Torn across warp | 37.2N | LIKELY TO |
| Tear strength | 13937-2: 2000 | Min. of 20N in both the warp and | Torn across weft | 30.5N | MEET |
| | (electronic recording) | weft directions | | | CLASS 1 & |
| | | | | | CLASS 2 |
| 6.5 | ISO 5077 | Class 1 & 2 | Warp | Weft | FAIL |
| Dimensional | | Max ± 3% | −4.5 % | −5.0% | |

| | | | | |
|---|---|---|---|---|
| change | | (− indicates shrinkage) | (− indicates shrinkage) | |
| 6.7**** | ISO 15025: 2000 | Class 1 & 2 | Procedures A & B | LIKELY TO |
| Limited | | No flaming to top or side edge | No flaming to top or side edge | MEET |
| flame spread | | No hole formation (A only) | No hole formation | CLASS 1 & |
| (procedures A & B) | | No flaming or molten debris | No flaming or molten debris | CLASS 2 |
| | | Mean afterflame ≦ 2 s | No afterflame | |
| | | Mean afterglow ≦ 2 s | No afterglow | |
| 6.10 | EN 1149-2: 1997 | Class 1 & 2 | Resistance = 8.0 × 10⁶ | CLASS 1 & |
| Electrical Resistance | | Electrical resistance greater than | | CLASS 2 |
| ***** | | 10⁵ Ohms | | |

***test made on two warpway and weftway specimens only
****test made on one warpway and weftway specimen only and without pre-treatment
*****sub contracted test made by STFI

Performance Test—EN ISO 11612:2008

Standard: Clause 7.4—molten aluminium splash (D); Clause 7.5—molten iron splash (E); Clause 7.6—contact heat (F).

Pre-treatment: tests were made after 5 washing cycles in accordance with ISO 6330:2000. Procedure 6A at 40° C. drying procedure E: tumble try. The tumble drying was carried out after the completion of each wash.

TABLE 5
Standard ISO 11612: 2008-Test results for the blend of example 6.

| | | ISO 11612 Requirement & | | | | | | PASS/Fail |
|---|---|---|---|---|---|---|---|---|
| Clause | Test Method | Performance Levels | | | Results | | | or Class |
| 7.4 | ISO 9185 | Molten AL splash (g) | | | Spec | Poured(g) | Skin stimulant | LEVEL D1 |
| Molten Aluminium | | Performance levels | | | 1 | 205 | Damaged | |
| splash (D) | | | Min | Max | 2 | 102 | Undamaged | |
| | | D1 | 100 | <200 | 3 | 101 | Undamaged | |
| | | D2 | 200 | <350 | 4 | 104 | Undamaged | |
| | | D3 | 350 | | 5 | 101 | Undamaged | |
| 7.5 | ISO 9185 | Molten Iron splash (g) | | | Spec | Poured(g) | Skin stimulant | LEVEL E3 |
| Molten Iron Splash | | Performance levels | | | 1 | 201 | Undamaged | |
| (E) | | | Min | Max | 2 | 202 | Undamaged | |
| | | E1 | 60 | <120 | 3 | 202 | Undamaged | |
| | | E2 | 120 | <200 | 4 | 201 | Undamaged | |

| | | E3 | 200 | | | | |
|---|---|---|---|---|---|---|---|
| 7.6 | ISO 12127: 1996 | Threshold time (s) | | | Specimen 1 | 4.6 | NO LEVEL |
| Contact Heat (F)** | at 250° C. | Performance levels | | | Specimen 2 | 4.8 | |
| | | | Min | Max | Specimen 3 | 4.9 | |
| | | F1 | 5.0 | <10.0 | Result | 4.6 | |
| | | F2 | 10.0 | <15.0 | based on lowest | | |

| | |
|---|---|
| F3 | 15.0 |

**sub contracted test made by UKAS accredited laboratory

Performance Test—EN 469:2005

Standard: Clause 6.4—residual tensile strength of material when exposed to radian heat; Clause 6.8.2—surface wetting.

Pre-treatment: tests were made after 5 washing cycles in accordance with ISO 6330:2000. Procedure 6A at 40° C. drying procedure E: tumble dry. The tumble drying was carried out after the completion of each wash.

TABLE 6
Standard EN 469: 2005-Test results for the blend of example 6.

| | | ISO 11612 Requirement & | | | PASS/Fail |
|---|---|---|---|---|---|
| Clause | Test Method | Performance Levels | Results | | or Class |
| 6.4 | EN ISO 13934-1 | Each specimen shall have a | Weft | | LIKELY TO |
| Residual tensile | pre-treatment to | tensile strength ≧450 N | Specimen 1 | 810N | PASS |
| strength***** | EN ISO 6942: 2002 | | | | |
| | Method A, at heat | | | | |
| | flux density of | | | | |
| | 10 kW/m² | | | | |
| 6.8 | EN 24920: 1992 | Spray rate of ≧4 | Specimen 1 | 1 | FAIL |
| Surface wetting | | | | | |

*****test made on one weftway specimen only

The performance test results, for example 3 and 6 confirm the fabrics satisfy all of the desired requirements. In particular, the blend of example 3 was found to perform better than the blend of example 6 with regard to tensile strength, tear strength, electrical and contact heat resistivity. The Oekotex standard requirements were also satisfied for both samples 3 and 6 following respective testing.

The presents result confirm that the present fibre blend based on the combination of a modacrylic with a natural cellulosic material and a FR viscose, at the appropriate weight % is capable of satisfying different performance standards with regard to fabric safety. This is perhaps contrary to expectation as, for example, cotton fibres are not considered to be inherently flame resistant and are susceptible to burn. The inventors have realised a synergistic affect between the blend of a modacrylic with a natural cellulosic (natural cotton) and FR viscose. The effect is manifested in an observed increase in the combined limited oxygen index (LOI) of the fabric wherein the LOI of the blend is greater than the sum of the LOI of the individual components. As will be appreciated, the LOI refers to the minimum concentration of oxygen that will just support flaming combustion of a material. The affect of incorporating a natural cellulosic may be considered to increase the charring affect of fabric when exposed to extreme heat which increases the LOI by expelling oxygen within the matrix as the charred carbon barrier forms during initial heat contact.

The present invention is therefore advantageous for use as a ‘universal’ protective fabric that has exhibited proven performance as a protective layer to flame, electric discharge and molten metal hazards.

1. A flame retardant fibre blend comprising:
40% to 60% by weight of a modacrylic;
5% to 25% by weight of a naturally occurring cellulosic material; and
20% to 40% by weight of a FR viscose based material;
wherein any remaining weight % is made up of any one or a combination of the modacrylic, cellulosic material or FR viscose.

2. The fibre blend as claimed in claim 1 wherein the modacrylic comprises a copolymer of acrylonitrile and vinyl chloride and/or vinylidene chloride.

3. The fibre blend as claimed in claim 1 wherein the modacrylic comprises:
30% to 70% by weight of acrylonitrile; and
70% to 30% by weight of vinyl chloride and/or vinylidene chloride.

4. The fibre blend as claimed in claim 1 wherein the modacrylic comprises vinylidene chloride and antimony oxide.

5. The fibre blend as claimed in claim 4 wherein the antimony oxide comprises antimony trioxide.

6. The fibre blend as claimed in claim 4 wherein the antimony oxide comprises antimony pentoxide.

7. The fibre blend as claimed in claim 1 wherein the naturally occurring cellulosic material comprises any one or a combination of the following set of:
Cotton;
Bamboo;
Linen; and/or
Jute.

8. The fibre blend as claimed in claim 1 further comprising nylon.

9. The fibre blend as claimed in claim 8 comprising trace to 7% by weight nylon.

10. The fibre blend as claimed in claim 8 comprising trace to 5% by weight nylon.

11. The fibre blend as claimed in claim 1 further comprising trace to 5% by weight of an antistatic material.

12. (canceled)

13. The fibre blend as claimed in claim 1 comprising:
40% to 55% by weight of the modacrylic;
10% to 20% by weight of the naturally occurring cellulosic material; and
25% to 35% by weight of the FR viscose based material.

14. The fibre blend as claim in claim 1 comprising:
45% to 55% by weight of a modacrylic comprising a copolymer of acrylonitrile and a halogen-containing vinyl monomer, the copolymer further comprising antimony pentoxide;
10% to 20% by weight of natural cotton;
25% to 35% by weight of FR viscose;
trace to 7% by weight nylon; and
trace to 5% by weight of a carbon based antistatic material.

15. A fabric comprising fibres according to claim 1.

16. The fabric as claimed in claim 14 wherein the fabric is woven, knitted or non-woven.

17. A garment comprising a fabric according to claim 15.

18. A flame retardant fibre blend comprising:
40% to 60% by weight of a modacrylic;
5% to 25% by weight of a synthetic non-FR enhanced cellulosic; and
20% to 40% by weight of a FR viscose based material;
wherein any remaining weight % is made up of any one or a combination of the modacrylic, cellulosic or FR viscose.

19. A garment comprising a fabric according to claim 16.
